(19) United States
(12) Patent Application Publication
(10) Pub. No.: US 2016/0229272 A1
(43) Pub. Date: Aug. 11, 2016

(54) VEHICLE WATER DISCHARGE STRUCTURE

(71) Applicants: TOYOTA JIDOSHA KABUSHIKI KAISHA, Toyota-shi (JP); VTEC CO., LTD., Anjou-shi (JP)

(72) Inventors: Chengshu GUO, Miyoshi-shi (JP); Akira MATSUURA, Toyota-shi (JP); Kouji SUZUKI, Nishio-shi (JP); Yoshitaka NAKAMURA, Nagoya-shi (JP); Hiroyuki ONO, Nagoya-shi (JP)

(73) Assignees: TOYOTA JIDOSHA KABUSHIKI KAISHA, Toyota-shi (JP); VTEC CO., LTD., Anjou-shi (JP)

(21) Appl. No.: 15/007,841

(22) Filed: Jan. 27, 2016

(30) Foreign Application Priority Data
Feb. 6, 2015 (JP) 2015-022395

(51) Int. Cl. B60J 7/00; B60J 10/90; B60J 10/25

(52) U.S. Cl. CPC B60J 7/0084; B60J 10/25; B60J 10/90

(57) ABSTRACT

An upper end portion 24A of a sunroof drain hose 24 that guides water in a water discharge groove section 22 in a vehicle downward direction is in communication with the water discharge groove section 22 formed on a vehicle cabin side of a sunroof opening portion 14. A grommet 30 is connected to a lower end of the sunroof drain hose 24. The grommet 30 includes a main body member 32, a cap member 40, and a cover member 50. The cap member 40 is capable of opening and closing, and is disposed at a discharge outlet 32B that is an outlet of a flow path 32A formed inside a main body member 32.

### CROSS-REFERENCE TO RELATED APPLICATION

This application is based on and claims priority under 35 USC 119 from Japanese Patent Application No. 2015-022395 filed on Feb. 6, 2015, the disclosure of which is incorporated by reference herein.

### BACKGROUND OF THE INVENTION

1. Technical Field

The present invention relates to a vehicle water discharge structure that is provided to an opening for a vehicle sunroof, and that discharges water in a water discharge groove to the vehicle outside.

2. Related Art

Ordinary sunroofs are provided with a water discharge groove that receives water entering the vehicle cabin from an opening of the sunroof, and water in the water discharge groove is guided to the vehicle lower side by a drain hose and discharged to the vehicle outside. For example, in a vehicle water discharge structure described by Japanese Patent Application Laid-Open (JP-A) No. 2009-35017, water that has entered a water discharge groove provided at a peripheral edge of an opening of a sunroof is guided downward along a front pillar by a water discharge pipe, and is discharged to an engine room through a water discharge plug. A discharge outlet at the downstream end of the water discharge pipe is attached to a cowl box by the water discharge plug.

In the configuration described by the above document, there is a concern that foreign matter may enter through the discharge outlet since the discharge outlet is in an open state. Although it is conceivable that the radius of the discharge outlet could be reduced to suppress foreign matter from entering, reducing the radius of the discharge outlet makes the discharge outlet liable to become blocked due to freezing.

### SUMMARY

In consideration of the above particulars, an object of the present invention is to obtain a vehicle water discharge structure that is capable of suppressing foreign matter from entering through a discharge outlet.

A vehicle water discharge structure according to a first aspect of the present invention includes a water discharge groove section provided at a vehicle cabin inner side of a vehicle sunroof opening portion, a water discharge path member that is in communication with the water discharge groove section, and that guides water in the water discharge groove section in a vehicle downward direction, and a cap member that is installed at a water discharge section through which water is discharged through the water discharge path member, and that is capable of moving to an open position that opens a discharge outlet of the discharge section and a blocking position that blocks the discharge outlet.

In the vehicle water discharge structure according to the first aspect, water entering into the water discharge groove from the vehicle sunroof opening portion is guided in the vehicle downward direction through the water discharge path member, and is discharged from the discharge section. The cap member is installed at the discharge outlet of the discharge section, and is capable of opening and closing the discharge outlet. Accordingly, the cap member can be disposed in the blocking position, thereby closing the discharge outlet, and this enables entry of foreign matter to be suppressed. Conversely, when there is no concern regarding entry of foreign matter to the discharge outlet, the cap member can be disposed in the open position, thereby opening the discharge outlet, and this enables water to be discharged.

In a vehicle water discharge structure according to a second aspect of the present invention, the cap member is ordinarily disposed in the open position, and is disposed in the blocking position when an inside of the vehicle cabin is at lower pressure than a vehicle outside.

When the inside of the vehicle cabin is at a lower pressure than the vehicle outside, foreign matter is more liable to enter the inside of the vehicle cabin through the discharge outlet. The vehicle water discharge structure according to the second aspect is therefore configured such that when the inside of the vehicle cabin reaches a lower pressure than the vehicle outside, the cap member is disposed in the blocking position, and the discharge outlet is closed. This enables entry of foreign matter through the discharge outlet to be suppressed. However, the cap member is ordinarily disposed in the open position, thereby opening the discharge outlet. This enables the discharge outlet to be suppressed from freezing in a state in which the cap member is disposed in the blocking position such that the discharge outlet adopts a blocked state due to freezing.

In a vehicle water discharge structure according to a third aspect of the present invention, the discharge outlet of the discharge section is disposed inclined toward a vehicle lower side, and the cap member hangs down from an upper edge of the discharge outlet of the discharge section, and can move between the blocking position and the open position by swinging about the upper edge of the discharge outlet.

In the vehicle water discharge structure according to the third aspect, the discharge outlet of the discharge section is disposed inclined toward the vehicle lower side. Moreover, the cap member hangs down from the upper edge of the discharge outlet of the discharge section, and can move between the blocking position and the open position by swinging about the upper edge of the discharge outlet. According to the above configuration, the cap member can be moved, and the discharge outlet opened and closed, using a simple configuration.

A vehicle water discharge structure according to a fourth aspect of the present invention further includes a cover member that covers the cap member, and that is open at a vehicle lower side.

According to the vehicle water discharge structure of the fourth aspect, the cap member is covered by the cover member, thereby enabling the cap member to be made less vulnerable to travelling airflow and other external influences.

### Advantageous Effects of Invention

In the vehicle water discharge structure according to the first aspect, since the cap member that opens and closes the discharge outlet is provided, the discharge outlet can be opened and closed as necessary, enabling foreign matter to be suppressed from entering through the discharge outlet.

According to the vehicle water discharge structure according to the second aspect, foreign matter can be suppressed from entering through the discharge outlet more effectively, and the discharge outlet can be suppressed from blocking due to freezing.

The vehicle water discharge structure according to the third aspect enables the cap member to be configured simply.

The vehicle water discharge structure according the fourth aspect enables the cap member to be protected.

### BRIEF DESCRIPTION OF THE DRAWINGS

Embodiments of the present invention will be described in detail based on the following figures, wherein:

FIG. 1 is a perspective view of a vehicle applied with a vehicle water discharge structure according to an exemplary embodiment;

FIG. 2 is an expanded cross-section taken along line A-A in FIG. 1;

FIG. 3 is a perspective view of a main body member, a cap member, and a cover member, which configure a portion of a vehicle water discharge structure of the exemplary embodiment, prior to assembly;

FIG. 4 is a cross-section of a main body member, a cap member, and a cover member, which configure a portion of a vehicle water discharge structure of the exemplary embodiment, in an assembled state; and

FIG. 5 is a side face view illustrating a state in which snow is piled up on the roof of a vehicle applied with the vehicle water discharge structure of the exemplary embodiment.

### DETAILED DESCRIPTION OF THE INVENTION

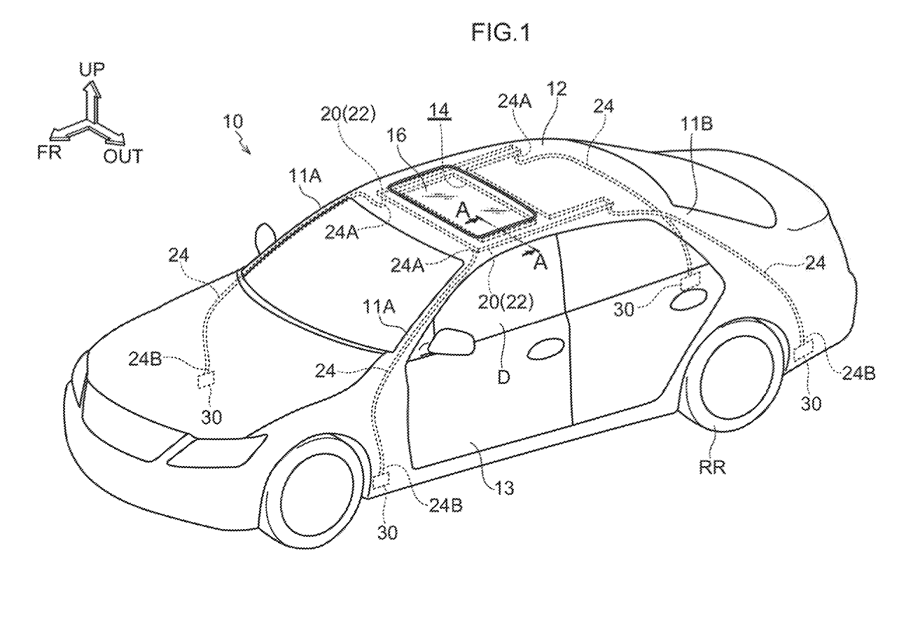

Explanation next follows regarding a vehicle water discharge structure according to an exemplary embodiment of the present invention, with reference to FIG. 1 to FIG. 4. In the drawings, the arrow FR indicates the vehicle front rear direction front side, the arrow OUT indicates the vehicle width direction outside, and the arrow UP indicates the vehicle up-down direction upper side. In the following explanation, reference to the front-rear and up-down directions indicates forward and backward in the vehicle front-rear direction and upward and downward in the vehicle up-down direction, unless otherwise stated.

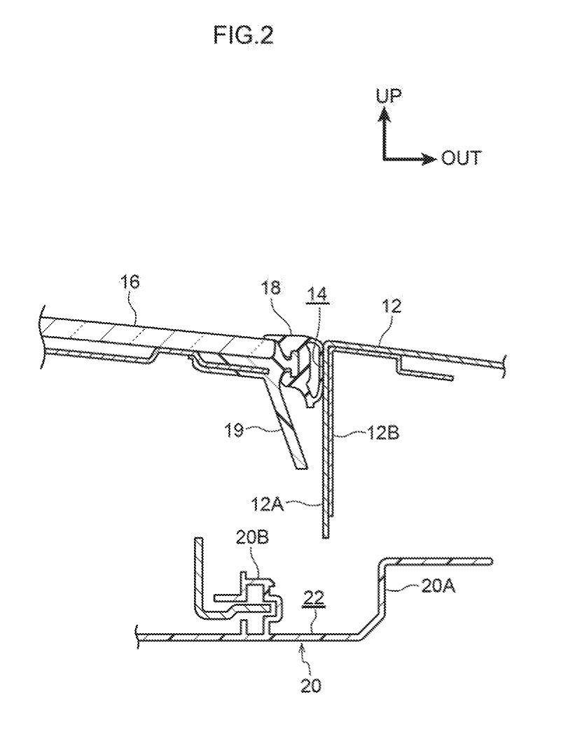

As illustrated in FIG. 1, a substantially rectangular sunroof opening portion 14 is formed on a roof 12 of a vehicle 10. As illustrated in FIG. 2, a downward bend portion 12A is formed by bending the roof 12 downward at a peripheral edge portion of the sunroof opening portion 14. A reinforcement member 12B running along a corner portion, which is configured by the roof 12 and the downward bend portion 12A, is joined to the inside of the corner portion.

Sliding glass 16 (also referred to as “sliding roof glass”), serving as an openable/closable moving panel, is disposed in the sunroof opening portion 14. The sliding glass 16 is a glass panel, and as illustrated in FIG. 2, a rubber weather strip 18 is attached to an outer peripheral edge portion of the sliding glass 16 through a plate member 19, described below. An outer peripheral lower portion of the sliding glass 16 is provided with the plate member 19 that inclines so as to be disposed more toward the vehicle width direction outside on progression downward. The sliding glass 16 is configured openable and closable by being tilted up, tilted down, or moved in the front rear direction by an operation mechanism, not illustrated in the drawings.

As illustrated in FIG. 1 and FIG. 2, a pair of left and right guide rails 20 are disposed at both sides of the sunroof opening portion 14 inside the vehicle cabin. As illustrated in FIG. 1, the guide rails 20 extend along the vehicle front-rear direction in an elongated shape, and their rear end positions are set further to the vehicle rear side than the rear end position of the sunroof opening portion 14.

As illustrated in FIG. 2, a water discharge groove section 22 that is open at the vehicle upper side is formed to each of the guide rails 20. The water discharge groove section 22 is formed between an upright portion 20A at which a vehicle width direction outer end portion of the guide rail 20 bends toward the upper side, and a guiding member 20B to which the operating mechanism, not illustrated in the drawings, is attached for the purpose of operating the sliding glass 16. The water discharge groove section 22 is disposed at a position at the lower side of extensions from the plate member 19 and a leading end of the downward bend portion 12A. The water discharge groove section 22 is open at the vehicle cabin inside, and rainwater and the like entering between the weather strip 18 and the downward bend portion 12A is caught by the water discharge groove section 22.

Upper end portions 24A of sunroof drain hoses 24, serving as water discharge path members, are connected to both front and rear ends of the water discharge groove section 22. Water discharge outlets (not illustrated in the drawings) are formed in the water discharge groove section 22 at portions connected to the upper end portions 24A, and rainwater and the like received by the water discharge groove section 22 flows into the sunroof drain hoses 24 through these water discharge outlets.

Each sunroof drain hose 24 in communication with a front end of the water discharge groove section 22 extends downward along a front pillar 11A. A lower end portion 24B of the sunroof drain hose 24 is connected to a grommet 30 that serves as a discharge section. The grommet 30 is attached to a front body section 15A at a lower front portion of a front side door 13.

Each sunroof drain hose 24 in communication with a rear end of the water discharge groove section 22 extends downward along a rear pillar 11B. The lower end portion 24B of the sunroof drain hose 24 is connected to a grommet 30. The grommet 30 is attached to a rear body section 15B at the back of a bumper that is further to the rear than a rear wheel RR.

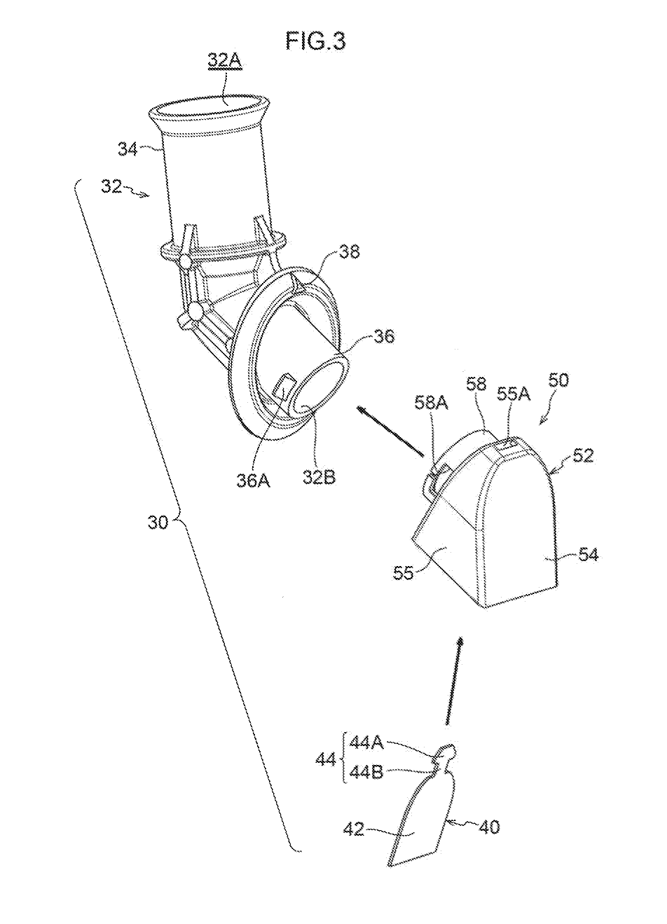

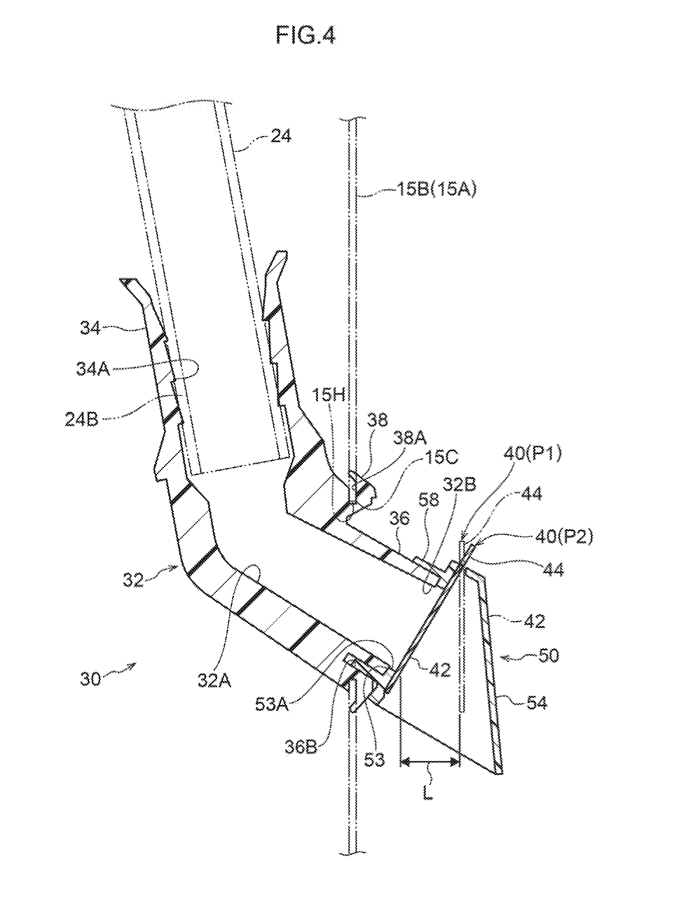

As illustrated in FIG. 3 and FIG. 4, each grommet 30 includes a main body member 32, a cap member 40, and a cover member 50. The main body member 32 serves as a discharge section and is tube shaped, and a flow path 32A is formed inside the main body member 32. A central portion of the main body member 32 is curved. As illustrated in FIG. 4, an inner wall of one end portion 34 of the main body member 32 forms a saw-tooth shaped retaining portion 34A. The lower end portion 24B of the sunroof drain hose 24 is inserted into the one end portion 34 of the main body member 32, and retained by the retaining portion 34A. A ring shaped contact portion 38 for attachment to the front body section 15A or the rear body section 15B of the vehicle 10 is formed to the outer periphery of the main body member 32. A groove 38A, to which an outer edge 15C of a body opening 15H formed to the front body section 15A or the rear body section 15B is engaged, is formed to a base on the one end portion 34 side of the contact portion 38.

A discharge outlet 32B, which is an outlet of the flow path 32A, is formed to another end portion 36 of the main body member 32. The discharge outlet 32B is disposed inclined such that the opening direction thereof faces downward with respect to the horizontal direction. A claw 36A, which engages to an engagement hole 58A of the cover member 50, described below, is formed to the outer periphery of the other end portion 36 (see FIG. 3). An insertion groove 36B, into which is inserted an outer fitting portion 58 of the cover member 50, described below, is formed to a lower portion of the outside of the discharge outlet 32B of the other end portion 36, between the discharge outlet 32B and the contact portion 38.

The cover member 50 includes a cover main body 52, and the outer fitting portion 58. The cover main body 52 is open at a lower portion thereof, and includes a bell shaped attachment face portion 53 positioned facing the discharge outlet 32B on the side at which the main body member 32 is attached. An opening 53A is formed to the attachment face portion 53. A main body plate 54 is disposed separated from the attachment face portion 53, at a position facing the attachment face portion 53 of the cover main body 52. The main body plate 54 is disposed along the vertical direction. A side plate 55 is disposed between an outer edge of the main body plate 54 and an outer edge of the attachment face portion 53, so as to connect the main body plate 54 and the attachment face portion 53 together. A slit shaped attachment hole 55A for attaching the cap member 40 is formed to an upper portion of the side plate 55. The attachment hole 55A is disposed at an upper edge of the discharge outlet 32B.

The outer fitting portion 58 is circular tube shaped, and is formed projecting from the outer circumference of the opening 53A toward the opposite side to the main body plate 54. The engagement hole 58A is formed to the outer fitting portion 58. The claw 36A of the main body member 32 is engaged to the engagement hole 58A. The outer fitting portion 58 is fitted over the other end portion 36 of the main body member 32, and a lower portion of the outer fitting portion 58 is inserted into the insertion groove 36B.

The cap member 40 is plate shaped, and includes a cap main body 42 and an attachment portion 44. The cap main body 42 has a shape substantially the same as that of the attachment face portion 53. The attachment portion 44 includes a neck portion 44B capable of being inserted into the attachment hole 55A, and a projecting portion 44A that is wider than the length of the length direction of the attachment hole 55A. The attachment portion 44 is integrally formed to an upper portion of the cap main body 42. The neck portion 44B of the cap member 40 is inserted through the attachment hole 55A, and the projecting portion 44A projects upward from the attachment hole 55A, such that the cap member 40 hangs down in the vertical direction under its own weight, and is attached to the cover member 50. The cap main body 42 is housed in the cover member 50.

The cap member 40 is configured capable of swinging about the neck portion 44B, and is ordinarily (when the vehicle cabin is not negatively pressurized) positioned along the vertical direction by its own weight. This position is referred to as an “open position P1” hereafter. When the inside of the vehicle cabin has been negatively pressurized, the cap member 40 is pulled to the flow path 32A side and is disposed in a blocking position that blocks the discharge outlet 32B. When the cap member 40 is disposed at the open position P1, a lower end of the discharge outlet 32B is separated from the cap member 40 by a distance L. The distance L is preferably 3 mm or more. This is because it is conceivable that the discharge outlet 32B could become blocked when water adhered to the vicinity of the discharge outlet 32B freezes if the distance L is less than 3 mm. The cap member 40 may be formed from a rubber material or a resin material.

Explanation next follows regarding operation and advantageous effects of the present exemplary embodiment.

First, the cap member 40 is attached to the cover member 50, and then the cover member 50 is attached to the main body member 32. The cap member 40 is attached to the cover member 50 by causing the projecting portion 44A to project from the attachment hole 55A. The cover member 50 is attached to the main body member 32 by fitting the outer fitting portion 58 over the other end portion 36 of the main body member 32, inserting the lower portion of the outer fitting portion 58 into the insertion groove 36B, and causing the claw 36A to engage with the engagement hole 58A.

Next, main body members 32 are respectively attached to the front body section 15A or the rear body section 15B. During the attachment, the one end portion 34 is inserted into the body opening 15H formed in the front body section 15A or the rear body section 15B, the contact portion 38 is caused to contact the front body section 15A or the rear body section 15B, and the outer edge 15C is caused to engage with the groove 38A. The main body member 32, the cap member 40, and the cover member 50 are thereby respectively attached to the front body section 15A or the rear body section 15B. The lower end portion 24B of the sunroof drain hose 24 is then inserted into the one end portion 34 of the main body member 32, and retained by the retaining portion 34A.

Ordinarily (when the inside of the vehicle cabin is not negatively pressurized), the cap member 40 is disposed in the open position P1, and the discharge outlet 32B is open. Rainwater or the like that has entered between the weather strip 18 and the downward bend portion 12A is caught by the water discharge groove section 22, and discharged from the discharge outlet 32B to the vehicle outside through the sunroof drain hose 24.

However, when the inside of the vehicle cabin is negatively pressurized while the vehicle 10 is travelling due to the sliding glass 16 being tilted up, door glass D being opened, or the like, the cap member 40 is pulled to the discharge outlet 32B side, and is disposed in the blocking position. This blocks the discharge outlet 32B and enables foreign matter (for example, exhaust gasses, sand, and dust) to be suppressed from entering the water discharge groove section 22 through the discharge outlet 32B and via the flow path 32A.

The present exemplary embodiment enables a configuration in which the discharge outlet 32B is blocked by the cap member 40 when the inside of the vehicle cabin is negatively pressurized, and when the inside of the vehicle cabin is not negatively pressurized, the discharge outlet 32B is opened and the cap member 40 is separated from the discharge outlet 32B. Accordingly, the discharge outlet 32B can be opened and closed when necessary and foreign matter can be suppressed from entering through the discharge outlet 32B, and the discharge outlet can be suppressed from being blocked due to freezing by separating the cap member 40 from the discharge outlet 32B.

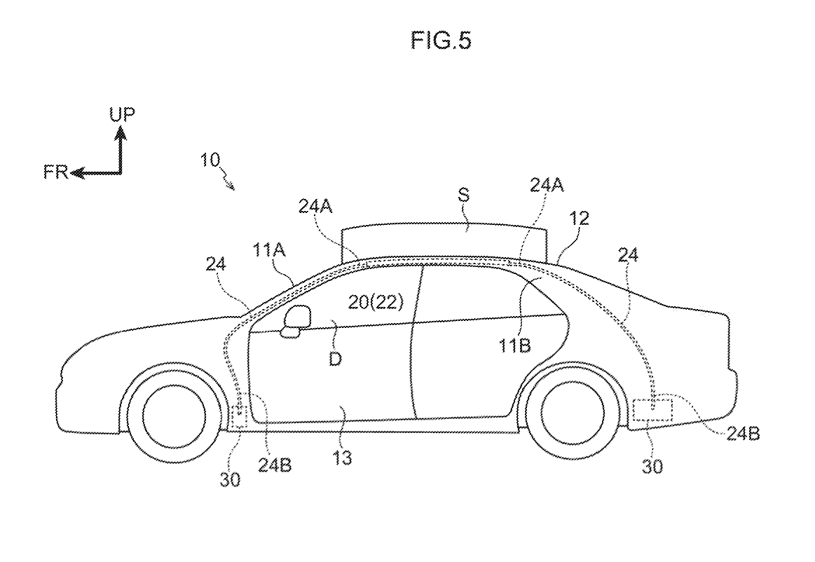

As an example in which freezing is anticipated, as illustrated in FIG. 5, a case can be conceived of in which snow S piled up on the roof 12 is thawed due to being heated by sunlight. When the snow on the roof 12 melts to become water, the water enters between the weather strip 18 and the downward bend portion 12A, and is discharged from the discharge outlet 32B to the vehicle outside through the water discharge groove section 22 and the sunroof drain hose 24. At this time, in cases in which the vehicle 10 is stationary, the vicinity of the discharge outlet 32B is at a low temperature since it is shaded from the sun, and water from above is liable to freeze.

As described above, in the present exemplary embodiment, the cap member 40 is disposed in the open position P1 when the vehicle 10 is stationary, thus suppressing blocking due to freezing, and enabling the discharge outlet to be suppressed from blocking due to freezing. Suppressing freezing enables water to be suppressed from backflowing through the flow path 32A and overflowing into the inside of the vehicle cabin.

Although the present exemplary embodiment has a configuration in which the cap member 40 is opened and closed using pressure fluctuations of the inside of the vehicle cabin with respect to the vehicle outside, the cap member 40 may be opened and closed by another method. For example, the cap member 40 may be moved so as to be disposed in the blocking position P2 coordinated with the sliding glass 16 being tilted up, or the door glass D being opened while the vehicle 10 is travelling In such cases, a solenoid valve or the like may be employed as the cap member 40, and may be opened and closed using electrical control. The discharge outlet 32B can be opened and closed using a simple configuration by utilizing a configuration in which the cap member 40 hangs down under its own weight and is moved into the blocking position P2 using negative pressure inside the vehicle cabin, as in the present exemplary embodiment.

Although the cap member 40 is housed inside the cover member 50 in the present exemplary embodiment, the cover member 50 is not strictly necessary. In cases lacking the cover member 50, the cap member 40 may be attached to a leading end upper portion of the other end portion 36. Since the cap member 40 is housed in the cover member 50 in the present exemplary embodiment, the cover member 50 functions as a windbreak, and the cap member 40 can be suppressed from swinging due to travelling airflow.

What is claimed is:

1. A vehicle water discharge structure comprising:
a water discharge groove section provided at a vehicle cabin inner side of a vehicle sunroof opening portion;
a water discharge path member that is in communication with the water discharge groove section, and that guides water in the water discharge groove section in a vehicle downward direction; and
a cap member that is installed at a water discharge section through which water is discharged through the water discharge path member, and that is capable of moving to an open position that opens a discharge outlet of the discharge section and a blocking position that blocks the discharge outlet.

2. The vehicle water discharge structure of claim 1, wherein
the cap member is ordinarily disposed in the open position, and is disposed in the blocking position when an inside of the vehicle cabin is at lower pressure than a vehicle outside.

3. The vehicle water discharge structure of claim 1, wherein:
the discharge outlet of the discharge section is disposed inclined toward a vehicle lower side; and
the cap member hangs down from an upper edge of the discharge outlet of the discharge section, and can move between the blocking position and the open position by swinging about the upper edge of the discharge outlet.

4. The vehicle water discharge structure of any one claim 1, further comprising
a cover member that covers the cap member, and that is open at a vehicle lower side.
